(19) United States
(12) Patent Application Publication
(10) Pub. No.: US 2026/0205553 A1
(43) Pub. Date: Jul. 16, 2026

(54) IMAGING APPARATUS

(71) Applicant: PFU LIMITED, ISHIKAWA (JP)

(72) Inventors: Kiichiro Shimosaka, ISHIKAWA (JP); Ryoichi Yasukawa, ISHIKAWA (JP)

(21) Appl. No.: 19/449,168

(22) Filed: Jan. 14, 2026

(30) Foreign Application Priority Data
Jan. 16, 2025 (JP) 2025-006238
Jan. 5, 2026 (JP) 2026-000506

(51) Int. Cl. H04N 1/00

(52) U.S. Cl. CPC H04N 1/00994; H04N 1/00559; H04N 1/00602; H04N 1/00604

(57) ABSTRACT

An imaging apparatus includes a conveying path inclined downward toward downstream in a medium conveying direction, a first imager to image a medium conveyed, a circuit board located below the conveying path, multiple electronic components mounted on the circuit board and having different heights, and a first shield located above the multiple electronic components to attenuate a radio wave generated by the first imager. The multiple electronic components include a first electronic component mounted on an upstream portion of the circuit board located below an upstream position in the medium conveying direction, and a second electronic component smaller in height than the first electronic component and mounted on a downstream portion of the circuit board located below a position downstream from the upstream position. The first shield is inclined downward from the first electronic component toward the second electronic component and covers an upper side of the multiple components.

### CROSS-REFERENCE TO RELATED APPLICATIONS

This patent application is based on and claims priority pursuant to 35 U.S.C. § 119(a) to Japanese Patent Application No. 2025-006238, filed on Jan. 16, 2025, in the Japan Patent Office, and Japanese Patent Application No. 2026-000506, filed on Jan. 5, 2026, in the Japan Patent Office, the entire disclosure of which is hereby incorporated by reference herein.

### BACKGROUND

The present disclosure relates to an imaging apparatus.

An image reading device includes an image reader, a display, and a circuit board. The image reader reads an image of a document being conveyed along a document conveying path. The display displays a read image of the document. The circuit board has at least one of the functions of driving the image reader and controlling the image reader. In this image reading device, the display and the circuit board are substantially parallel to the document conveying path.

Another document reading device includes an automatic document feeder, a reader employing a reduction-optical system, a scanner frame, and a converter. The reader is located inside the automatic document feeder. The scanner frame partitions inside and outside of the reader. The converter is located in the scanner frame to convert an image signal obtained by the reader through reading.

### SUMMARY

The imaging apparatus according to one aspect of the present disclosure includes a conveying path inclined downward from upstream toward downstream in a medium conveying direction, a first imager to image a medium that is conveyed, a circuit board located below the conveying path, multiple electronic components mounted on the circuit board and having different heights, and a first shield located above the multiple electronic components to attenuate a radio wave generated by the first imager. The multiple electronic components include a first electronic component mounted on an upstream portion of the circuit board located below an upstream position in the medium conveying direction, and a second electronic component smaller in height than the first electronic component and mounted on a downstream portion of the circuit board located below a position downstream from the upstream position in the medium conveying direction. The first shield is inclined downward from the first electronic component toward the second electronic component and covers an upper side of the multiple electronic component.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of an imaging apparatus;

FIG. 2 is a diagram illustrating a conveying path inside the imaging apparatus illustrated in FIG. 1;

FIG. 3 is a schematic diagram illustrating a processing circuit board and shields;

FIG. 4 is a schematic diagram illustrating the processing circuit board and the shields illustrated in FIG. 3;

FIG. 5 is a schematic diagram illustrating the processing circuit board and the shields illustrated in FIG. 3;

FIG. 6 is a schematic diagram illustrating straight lines;

FIG. 7 is a schematic diagram illustrating a second imaging device;

FIG. 8 is a perspective view of a processing circuit board and other members viewed from above on the upstream side;

FIG. 9 is a perspective view of a processing circuit board and other members viewed from the side;

FIG. 10 is a block diagram illustrating a schematic configuration of an imaging apparatus;

FIG. 11 is a block diagram illustrating a schematic configuration of a memory and a processing circuit;

FIG. 12 is a flowchart of a medium reading process;

FIG. 13 is a schematic diagram illustrating another imaging apparatus;

FIG. 14 is a diagram illustrating a structure inside the imaging apparatus illustrated in FIG. 13;

FIG. 15 is a block diagram illustrating a schematic configuration of another processing circuit; and

FIGS. 16A, 16B, and 16C are schematic diagrams illustrating arrangements of electronic components on a processing circuit board.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, imaging apparatuses according to embodiments of the present disclosure are described below. As used herein, the singular forms “a,” “an,” and “the” are intended to include the plural forms as well, unless the context clearly indicates otherwise.

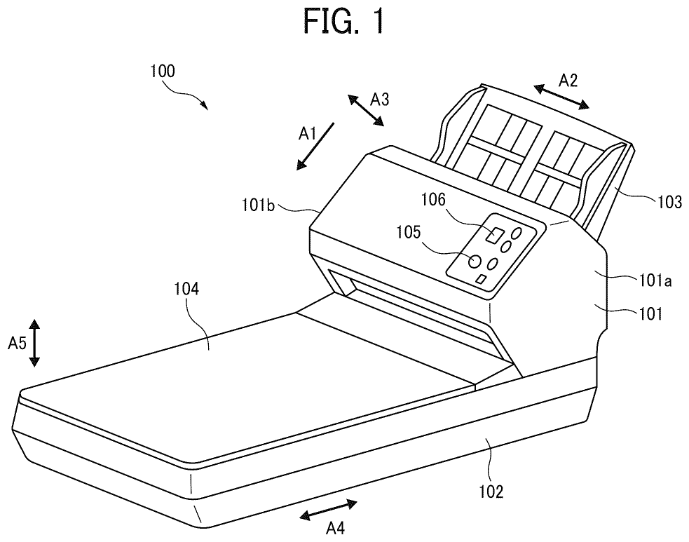

FIG. 1 is a perspective view of an imaging apparatus 100 that is an image scanner.

The imaging apparatus 100 has the functions of imaging a medium, which is a document, while conveying the medium, and imaging a medium placed on a transparent receiving surface without conveying the medium. Examples of the medium include paper, thick paper, a card, a booklet, and a passport. The imaging apparatus 100 may be an apparatus such as a facsimile machine.

In such apparatuses, it is desired to reduce the influence of a radio wave generated by a radio wave generation source without increasing the apparatus size.

In FIG. 1, arrow A1 indicates the direction in which a medium is conveyed (also “medium conveying direction A1”), arrow A2 indicates the width direction perpendicular to the medium conveying direction A1, and arrow A3 indicates the height direction perpendicular to a medium conveying path. Arrow A4 indicates the horizontal direction, and arrow A5 indicates the vertical direction. In the following, upstream is upstream in the medium conveying direction A1, and downstream is downstream in the medium conveying direction A1. The width direction A2 is an example of a direction intersecting a medium conveying direction.

The imaging apparatus 100 includes a first housing 101, a second housing 102, a first media tray 103, a cover 104, an operation device 105, and a display device 106.

The first housing 101 and components located in the first housing 101 function as an example of an automatic document feeder as well as an example of a scanner, perform imaging of a medium while conveying the medium with an automatic document feeder (ADF). This imaging method may be referred to as “ADF imaging” below. The second housing 102 and components located in the second housing 102 function as an example of a flatbed section as well as an example of the scanner, and perform imaging of a medium placed on a transparent receiving surface (a flatbed) without conveying the medium. This imaging method may be referred to as “flatbed imaging” below. The first housing 101 is located above the second housing 102. The first housing 101 includes a lower housing 101a and an upper housing 101b. The upper housing 101b covers the upper side of the imaging apparatus 100 and is hinged on the lower housing 101a such that the upper housing 101b is opened and closed, for example, to remove a jammed medium or clean the inside of the imaging apparatus 100.

The first media tray 103 is engaged with the lower housing 101a to support a medium or media to be conveyed in the first housing 101.

The cover 104 is hinged on the second housing 102 to be opened and closed relative to the second housing 102. When the cover 104 is closed relative to the second housing 102, the cover 104 covers the upper surface of the second housing 102 to function as an ejection tray onto which the medium ejected from the first housing 101 is ejected. When the cover 104 is opened relative to the second housing 102, the cover 104 exposes the upper surface of the second housing 102 to allow a user to place a medium on the upper surface of the second housing 102.

The operation device 105 includes an input device, such as a mechanical button, and an interface circuit that obtains signals from the input device. The operation device 105 receives an operation performed by a user and outputs a signal corresponding to the operation performed by the user. The display device 106 includes an output device, such as a light-emitting diode (LED), and an interface circuit that controls the output device. The display device 106 switches the LED on or off in accordance with an instruction from a processing circuit (described below). The display device 106 may include an output device, such as a liquid crystal display or organic electro-luminescence (EL) display, instead of the LED, and an interface circuit that outputs image data to the output device. The display device 106 may display a predetermined image in accordance with an instruction from the processing circuit. In this case, the operation device 105 may include an input device, such as a touch panel, instead of the mechanical button, and an interface circuit that obtains signals from the input device.

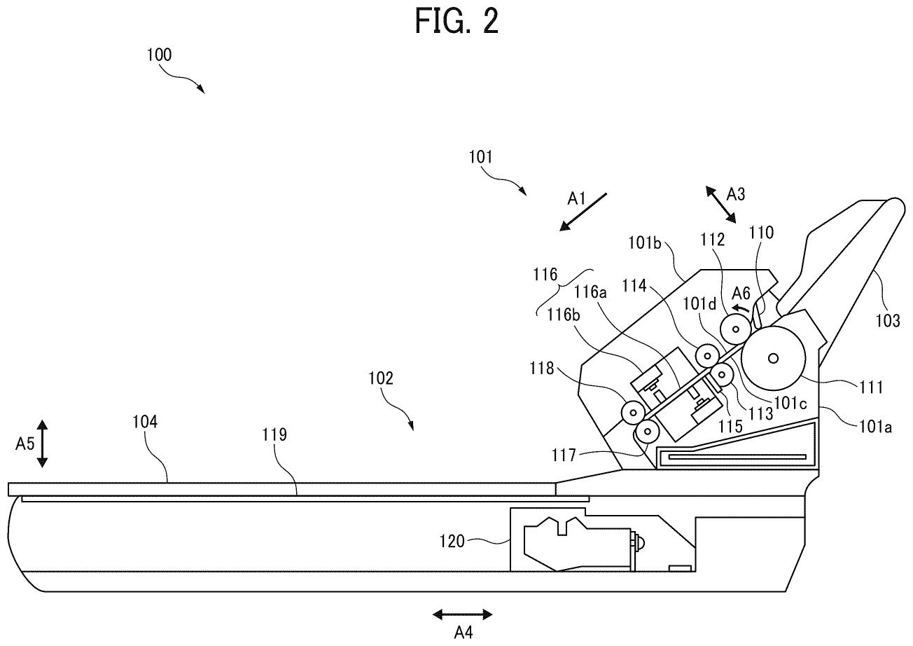

FIG. 2 is a diagram illustrating a structure inside the imaging apparatus 100.

The imaging apparatus 100 further includes a first media sensor 110, a feed roller 111, a separation roller 112, a first conveyance roller 113, a second conveyance roller 114, a second media sensor 115, a first imaging device 116 including an image sensor, a first ejection roller 117, a second ejection roller 118, a second media tray 119, and a second imaging device 120 including an image sensor. The first media sensor 110, the feed roller 111, the separation roller 112, the first conveyance roller 113, the second conveyance roller 114, the second media sensor 115, the first imaging device 116, the first ejection roller 117, and the second ejection roller 118 are located in the first housing 101. The second media tray 119 and the second imaging device 120 are located in the second housing 102.

The feed roller 111, the separation roller 112, the first conveyance roller 113, the second conveyance roller 114, the first ejection roller 117, and the second ejection roller 118 are examples of a conveyor, and convey media along the conveying path. The number of each of the feed roller 111, the separation roller 112, the first conveyance roller 113, the second conveyance roller 114, the first ejection roller 117, and/or the second ejection roller 118 is not limited to one and may be two or more. When the feed roller 111, the separation roller 112, the first conveyance roller 113, the second conveyance roller 114, the first ejection roller 117, and/or the second ejection roller 118 are formed of multiple rollers, the multiple rollers are located at intervals in the width direction A2.

The upper surface of the lower housing 101a forms a lower guide 101c for the medium conveying path. The lower surface of the upper housing 101b forms an upper guide 101d for the medium conveying path. The medium conveying path is a so-called straight path, and the vertical relative positions of the front side and the back side of a medium do not change between when the medium is fed from the first media tray 103 and when the medium is ejected onto the cover 104. The medium conveying path is inclined to be higher in the height direction A3 on the upstream side in the medium conveying direction A1, and lower in the height direction A3 on the downstream side in the medium conveying direction A1. In the medium conveying path, a feed port and an ejection port are inclined in the same direction to face downward and the downstream side. The medium conveying path having the straight path mechanism allows the imaging apparatus 100 to favorably convey a thick medium such as thick paper, a card, or a passport. The medium conveying path having the straight path mechanism also allows the imaging apparatus 100 to consecutively convey many media collectively placed on the first media tray 103.

The first media sensor 110 is located upstream from the feed roller 111 and the separation roller 112. The first media sensor 110 includes a contact sensor and detects whether a medium is placed on the first media tray 103. The first media sensor 110 generates and outputs a first media signal whose signal value changes depending on whether a medium is placed on the first media tray 103. The first media sensor 110 is not limited to a contact sensor. The first media sensor 110 may be any other sensor that detects the presence of a medium, such as an optical sensor.

The feed roller 111 and the separation roller 112 are an example of a feeder and an example of a separator, respectively. The feed roller 111 is located in the lower housing 101a. The feed roller 111 separates and feeds media placed on the first media tray 103 sequentially from the bottom. The separation roller 112 is a so-called brake roller or retard roller and is located in the upper housing 101b to face the feed roller 111. The separation roller 112 separates a medium from the media placed on the first media tray 103. The separation roller 112 is rotatable in the direction indicated by arrow A6 opposite to the rotation direction for feeding the media (hereinafter referred to as a medium feeding direction). Alternatively, the separation roller 112 is stoppable. The feed roller 111 may be located in the upper housing 101b, the separation roller 112 may be located in the lower housing 101a, and the feed roller 111 may separate and feed the media placed on the first media tray 103 sequentially from the top. The separation roller 112 may be substituted by a separation pad.

The first conveyance roller 113 and the second conveyance roller 114 are an example of a conveyor. The first conveyance roller 113 and the second conveyance roller 114 are located downstream from the feed roller 111 and the separation roller 112 in the medium conveying direction A1 and face each other. The first conveyance roller 113 and the second conveyance roller 114 convey the medium fed by the feed roller 111 and the separation roller 112 to the first imaging device 116.

The second media sensor 115 is located downstream from the first conveyance roller 113 and the second conveyance roller 114 and upstream from the first imaging device 116, and detects the leading end and the trailing end of the medium conveyed to the position where the second media sensor 115 is located. The second media sensor 115 includes a light emitter, a light receiver, and a light guide. The light emitter and the light receiver are located on one side of the medium conveying path. The light guide faces the light emitter and the light receiver across the medium conveying path. For example, the light guide is a U-shaped prism. The light emitter is, for example, an LED and emits light toward the medium conveying path. The light receiver is, for example, a photodiode and receives the light emitted from the light emitter and guided by the light guide. When a medium is present at the position facing the second media sensor 115, the light emitted from the light emitter is blocked by the medium. Thus, the light receiver does not detect the light emitted from the light emitter. The light receiver generates and outputs a second media signal based on the intensity of the light received. The second media signal changes in signal value depending on whether a medium is present at the position of the second media sensor 115.

The light guide may be substituted by a reflector, such as a mirror. The light emitter and the light receiver may be located to face each other across the medium conveying path. The second media sensor 115 may detect the presence of a medium using, for example, a contact sensor that causes a predetermined amount of electrical current to flow when a medium is in contact or not in contact with the contact sensor.

The first imaging device 116 images the medium conveyed by the first conveyance roller 113 and the second conveyance roller 114. The first imaging device 116 includes a lower imaging device 116a and an upper imaging device 116b facing each other across the medium conveying path. The first imaging device 116 will be described in detail.

The first ejection roller 117 and the second ejection roller 118 are an example of an ejector. The first ejection roller 117 and the second ejection roller 118 are located downstream from the first imaging device 116 and face each other. The first ejection roller 117 and the second ejection roller 118 eject the medium that is conveyed by the first conveyance roller 113 and the second conveyance roller 114 and is imaged by the first imaging device 116 onto the cover 104.

As the feed roller 111 rotates in the medium feeding direction, the medium placed on the first media tray 103 is conveyed in the medium conveying direction A1 between the lower guide 101c and the upper guide 101d. The separation roller 112 rotates in the direction opposite to the medium feeding direction or stops while the medium is conveyed. When multiple media are placed on the first media tray 103, only the medium in contact with the feed roller 111 is separated from the rest of the media on the first media tray 103 due to the action of the feed roller 111 and the separation roller 112. This operation prevents a medium other than the separated medium from being conveyed (prevents multi-feed).

The medium is fed between the first conveyance roller 113 and the second conveyance roller 114 while being guided by the lower guide 101c and the upper guide 101d. As the first conveyance roller 113 and the second conveyance roller 114 rotate, the medium is fed between the lower imaging device 116a and the upper imaging device 116b. As the first ejection roller 117 and the second ejection roller 118 rotate, the medium read by the first imaging device 116 is ejected to the cover 104.

The second media tray 119 is located on the upper surface of the second housing 102 to support a medium. The second media tray 119 is formed of a light-transmitting member such as transparent glass or plastic. The second media tray 119 has a receiving surface that extends in the same direction as the bottom surface of the second housing 102, that is, in the same direction as the horizontal direction A4.

The second imaging device 120 moves horizontally in the direction in which the receiving surface of the second media tray 119 extends, and images a medium placed on the second media tray 119. The second imaging device 120 will be described in detail below.

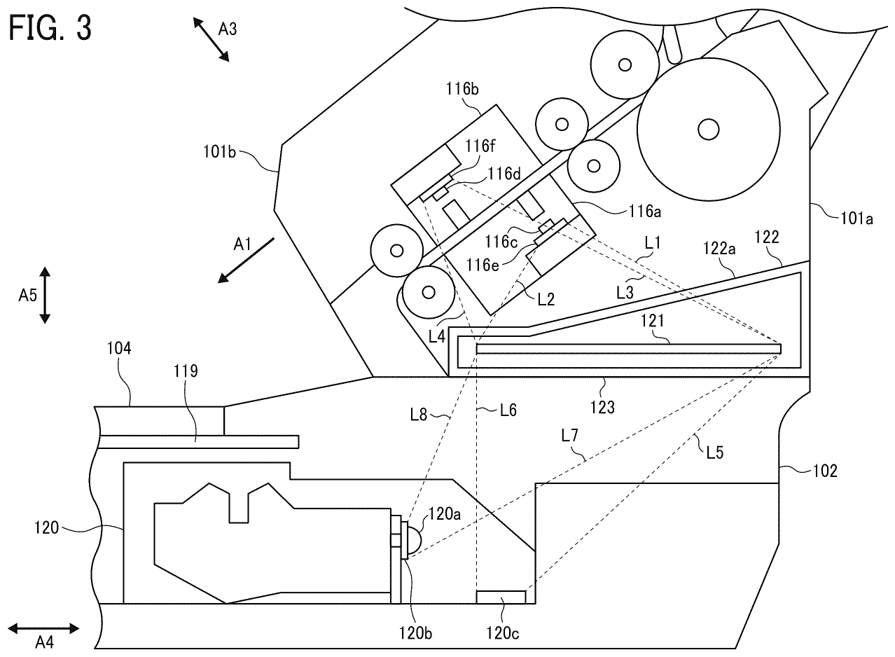

FIGS. 3 to 5 are schematic diagrams illustrating a processing circuit board 121 and shields.

As illustrated in FIGS. 3 to 5, the imaging apparatus 100 further includes the processing circuit board 121, a first shield 122, and a second shield 123. The processing circuit board 121, the first shield 122, and the second shield 123 are located in the lower housing 101a.

The lower imaging device 116a includes a lower imaging sensor 116c and a lower imaging sensor circuit board 116e. The lower imaging sensor 116c employs a unity-magnification contact image sensor (CIS), and the CIS includes complementary metal oxide semiconductor (CMOS) imaging elements arrayed in line in the main scanning direction. The lower imaging device 116a further includes a lens and an analog-to-digital (A/D) converter. The lens forms an image on the imaging elements. The A/D converter amplifies electrical signals output from the imaging elements and performs A/D conversion. The lower imaging sensor 116c and the A/D converter image the front side of a medium being conveyed and generate and output a first input image. The lower imaging sensor circuit board 116e is a printed circuit board on which multiple electronic components and/or conductors, including the lower imaging sensor 116c and the A/D converter, are mounted. The electronic components include various components, such as a central processing unit (CPU), an integrated circuit (IC), a large scale integration (LSI) chip, a System on a Chip (SoC), a random access memory (RAM), a read-only memory (ROM), a resistor, a coil, and a capacitor. The conductors include a wiring pattern printed or bonded on the board.

Likewise, the upper imaging device 116b includes an upper imaging sensor 116d and an upper imaging sensor circuit board 116f. The upper imaging sensor 116d is an imaging sensor that employs a unity-magnification CIS including CMOS imaging elements arrayed in line in the main scanning direction. The upper imaging device 116b further includes a lens and an A/D converter. The lens forms an image on the imaging elements. The A/D converter amplifies electrical signals output from the imaging elements and performs A/D conversion. The upper imaging sensor 116d and the A/D converter image the back side of a medium being conveyed and generate and output a first input image. The upper imaging sensor circuit board 116f is a printed circuit board on which electronic components and/or conductors, including the upper imaging sensor 116d and the A/D converter, are mounted.

The lower imaging sensor 116c and the upper imaging sensor 116d are each an example of a first imager included in an automatic document feeder or an imager included in a scanner. The electronic components and/or conductors mounted on the lower imaging sensor circuit board 116e and the electronic components and/or conductors mounted on the upper imaging sensor circuit board 116f are each an example of a first radio wave generation source and generate a predetermined radio wave. The imaging apparatus 100 may include either the lower imaging device 116a or the upper imaging device 116b and read only one side of the medium. The imaging sensor may be a line sensor that employs a unity-magnification CIS including charge coupled device (CCD) imaging elements. Alternatively, the imaging sensor may be a reduction-optical line sensor including CMOS or CCD imaging elements.

The second imaging device 120 includes a second imaging sensor 120a, a second imaging sensor circuit board 120b, and an interface circuit board 120c. The second imaging sensor 120a is a reduction-optical imaging sensor including CCD imaging elements arrayed in line in the main scanning direction. The second imaging device 120 further includes one or more mirrors, a lens, and an A/D converter. The one or more mirrors reflect light incident thereon. The lens forms an image on the imaging elements. The A/D converter amplifies electrical signals output from the imaging elements and performs A/D conversion. The second imaging sensor 120a and the A/D converter image a medium placed on the second media tray 119, generate a second input image, and output the second input image to the interface circuit board 120c. The second imaging sensor circuit board 120b is a printed circuit board on which electronic components and/or conductors, including the second imaging sensor 120a and the A/D converter, are mounted. The interface circuit board 120c includes an interface circuit that outputs (relays) the information input thereto. The interface circuit board 120c outputs, to the processing circuit board 121, the second input image output from the second imaging sensor 120a and the A/D converter, i.e., from the second imaging sensor circuit board 120b. The interface circuit board 120c is a printed circuit board on which electronic components and/or conductors, including the interface circuit, are mounted.

The second imaging sensor 120a is an example of a second imager included in the flatbed section. The electronic components and/or conductors mounted on the second imaging sensor circuit board 120b and the electronic components and/or conductors mounted on the interface circuit board 120c are each an example of a second radio wave generation source and generate a predetermined radio wave. The imaging sensor may be a reduction-optical line sensor including CMOS imaging elements. The imaging sensor may be a line sensor that employs a unity-magnification CIS including CCD or CMOS imaging elements.

The second imaging device 120 is movable in the horizontal direction A4, i.e., the sub-scanning direction by a second driving device (described below). FIGS. 3 to 5 illustrate the second imaging device 120 located at the extreme upstream position (i.e., the rightmost position in FIGS. 3 to 5). The second imaging sensor circuit board 120b is kept located downstream from the processing circuit board 121.

The processing circuit board 121 is an example of a circuit board. The processing circuit board 121 has, for example, an interface device, a memory, and a processing circuit (which are described later) mounted thereon. For example, the processing circuit board 121 extends in parallel to the bottom surface of the second housing 102, that is, in parallel to the horizontal direction A4. In some embodiments, the processing circuit board 121 does not extend in parallel to the bottom surface of the second housing 102. The processing circuit board 121 at least partially overlaps the lower imaging sensor circuit board 116e or the upper imaging sensor circuit board 116f in the medium conveying direction A1. The processing circuit board 121 at least partially overlaps the second imaging sensor circuit board 120b or the interface circuit board 120c in the horizontal direction A4.

The first shield 122 faces the processing circuit board 121 to cover the upper surface of the processing circuit board 121. Thus, the first shield 122 shields the processing circuit board 121 to block (or attenuate) the radio wave propagating toward the processing circuit board 121 from above. The first shield 122 is formed of (composed of) a resin having a surface resistance value equal to or lower than 10¹⁰ Ω, a member coated with a conductive coating film, or a metal. The first shield 122 formed of any of such members can favorably block (or attenuate) radio waves emitted from the lower imaging sensor circuit board 116e and the upper imaging sensor circuit board 116f. The first shield 122 formed of a resin allows the imaging apparatus 100 to have a reduced apparatus weight and an increased design flexibility. On the other hand, the first shield 122 formed of a metal allows the imaging apparatus 100 to have a reduced surface resistance value of the first shield 122 and an enhanced radio wave blocking (or attenuating) performance.

The first shield 122 is located between the processing circuit board 121 and the lower imaging sensor circuit board 116e and between the processing circuit board 121 and the upper imaging sensor circuit board 116f. The first shield 122 at least partially overlaps the lower imaging sensor circuit board 116e or the upper imaging sensor circuit board 116f in the medium conveying direction A1. Thus, the first shield 122 can favorably reduce the radio waves reaching the processing circuit board 121 from the lower imaging sensor circuit board 116e and the upper imaging sensor circuit board 116f.

As illustrated in FIG. 3, when viewed in the width direction A2, the first shield 122 intersects a straight line L1 connecting the upstream end (right end in FIG. 3) of the electronic component (or the upstream end of the conductor) mounted on the lower imaging sensor circuit board 116e to the upstream end of the multiple electronic components (or the upstream end of the conductor) mounted on the processing circuit board 121. In FIG. 3, the end of the line L1 points at the upstream end of the lower imaging sensor circuit board 116e not the lower imaging sensor 116c mounted thereon. This is because a conductors (e.g., a wiring pattern) embedded on the circuit board typically extends near the end of the circuit board. When multiple items each of which is an electronic component or a conductor are mounted on the circuit board, the start or end of the straight line L1 is the upstream end of the extreme upstream one of the multiple items. This applies to other straight lines described below.

When viewed in the width direction A2, the first shield 122 intersects a straight line L2 connecting the downstream end (left end in FIG. 3) of the electronic component or conductor mounted on the lower imaging sensor circuit board 116e to the downstream end of the electronic component or conductor mounted on the processing circuit board 121. The straight lines L1 and L2 are examples of first and second straight lines, respectively. Thus, the first shield 122 can reduce the radio waves reaching the processing circuit board 121 from the lower imaging sensor circuit board 116e.

The upstream end, the downstream end, the upper end, the lower end, the left end, and the right end of the electronic component or conductor mounted on each circuit board respectively indicate the extreme upstream position, the extreme downstream position, an uppermost position, a lowermost position, a leftmost position, and a rightmost position among positions where the electronic components and conductors are mounted on the circuit board. Alternatively, the upstream end, the downstream end, the upper end, the lower end, the left end, and the right end of the electronic component or conductor mounted on each circuit board may respectively indicate the extreme upstream position, the extreme downstream position, an uppermost position, a lowermost position, a leftmost position, and a rightmost position among positions where the electronic components are mounted on the circuit board. Alternatively, the upstream end, the downstream end, the upper end, the lower end, the left end, and the right end of the electronic component or conductor mounted on each circuit board may respectively indicate the extreme upstream position, the extreme downstream position, an uppermost position, a lowermost position, a leftmost position, and a rightmost position among positions where a major electronic component (i.e., the CPU, LSI, SoC, ROM, or RAM) is mounted on the circuit board. Alternatively, the upstream end, the downstream end, the upper end, the lower end, the left end, and the right end of the electronic component or conductor mounted on each circuit board may respectively indicate an upstream end position, a downstream end position, an upper end position, a lower end position, a left end position, and a right end position of each electronic component mounted on the circuit board. Alternatively, the upstream end, the downstream end, the upper end, the lower end, the left end, and the right end of the electronic component or conductor mounted on each circuit board may respectively indicate an upstream end position, a downstream end position, an upper end position, a lower end position, a left end position, and a right end position of each major electronic component mounted on the circuit board. Alternatively, the upstream end, the downstream end, the upper end, the lower end, the left end, and the right end of the electronic component or conductor mounted on each circuit board may respectively indicate the extreme upstream position, the extreme downstream position, an uppermost position, a lowermost position, a leftmost position, and a rightmost position among positions where the conductors are mounted on the circuit board. Alternatively, the upstream end, the downstream end, the upper end, the lower end, the left end, and the right end of the electronic component or conductor mounted on each circuit board may respectively indicate an upstream end position, a downstream end position, an upper end position, a lower end position, a left end position, and a right end position of each continuous conductor mounted on the circuit board.

When viewed in the width direction A2, the first shield 122 intersects a straight line L3 connecting the upstream end of the electronic component or conductor mounted on the upper imaging sensor circuit board 116f to the upstream end of the electronic component or conductor mounted on the processing circuit board 121. When viewed in the width direction A2, the first shield 122 intersects a straight line L4 connecting the downstream end of the electronic component or conductor mounted on the upper imaging sensor circuit board 116f to the downstream end of the electronic component or conductor mounted on the processing circuit board 121. The straight lines L3 and L4 are examples of first and second straight lines, respectively. Thus, the first shield 122 can reduce the radio waves reaching the processing circuit board 121 from the upper imaging sensor circuit board 116f.

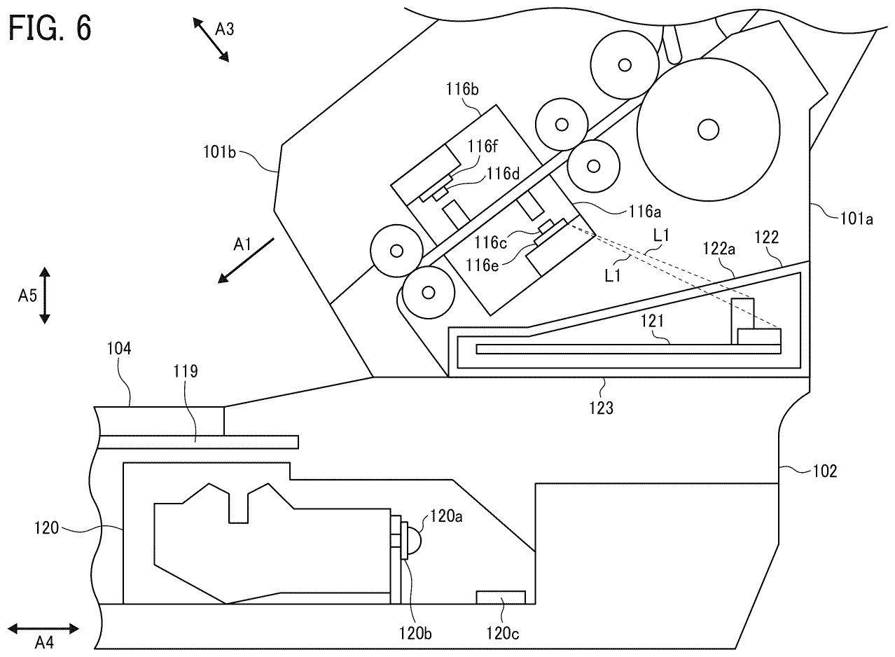

FIG. 6 is a schematic diagram illustrating the straight lines.

As illustrated in FIG. 6, when viewed in the width direction A2, the straight line L1 may be set to connect the lower end of the upstream end of the electronic component or conductor mounted on the lower imaging sensor circuit board 116e to the upper end of the upstream end of the electronic component or conductor mounted on the processing circuit board 121. Likewise, when viewed in the width direction A2, the straight line L2 illustrated in FIG. 3 may be set to connect the lower end of the downstream end of the electronic component or conductor mounted on the lower imaging sensor circuit board 116e to the upper end of the downstream end of the electronic component or conductor mounted on the processing circuit board 121. Likewise, when viewed in the width direction A2, the straight line L3 illustrated in FIG. 3 may be set to connect the lower end of the upstream end of the electronic component or conductor mounted on the upper imaging sensor circuit board 116f to the upper end of the upstream end of the electronic component or conductor mounted on the processing circuit board 121. Likewise, when viewed in the width direction A2, the straight line L4 illustrated in FIG. 3 may be set to connect the lower end of the downstream end of the electronic component or conductor mounted on the upper imaging sensor circuit board 116f to the upper end of the downstream end of the electronic component or conductor mounted on the processing circuit board 121. Alternatively, the end of the line L1 and the end of the line L3 may be at the upper end of the upstream end of the electronic component or conductor mounted on the circuit board, and the end of the line L2 and the end of the line L4 may be at the upper end of the downstream end of the electronic component or conductor mounted on the circuit board.

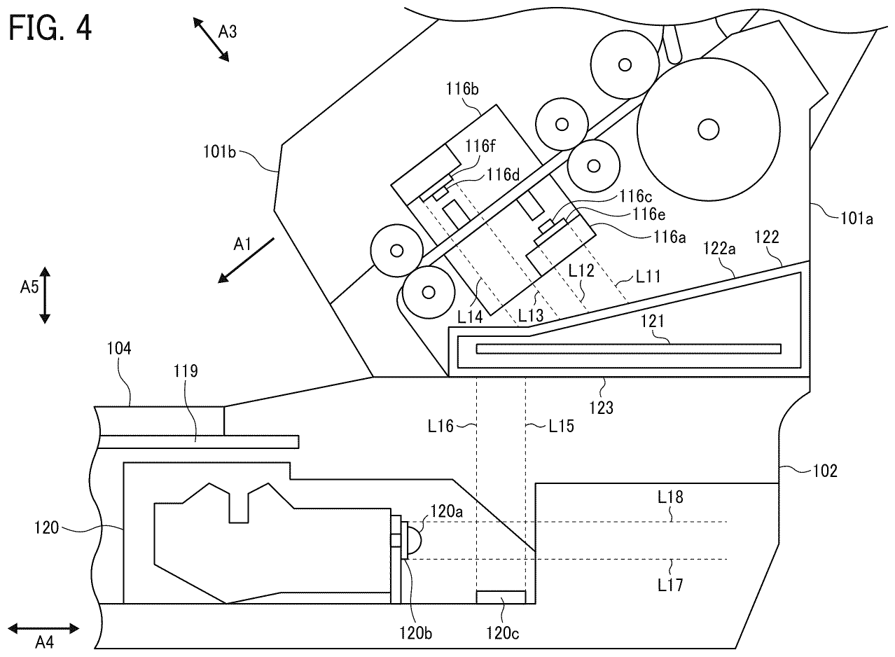

As illustrated in FIG. 4, when viewed in the width direction A2, the first shield 122 intersects a straight line L11 extending from the upstream end of the electronic component or conductor mounted on the lower imaging sensor circuit board 116e in a direction perpendicular to the extending direction of the lower imaging sensor circuit board 116e. When viewed in the width direction A2, the first shield 122 intersects a straight line L12 extending from the downstream end of the electronic component or conductor mounted on the lower imaging sensor circuit board 116e in a direction perpendicular to the extending direction of the lower imaging sensor circuit board 116e. The straight lines L11 and L12 are examples of first and second straight lines, respectively. Thus, the first shield 122 can reduce the radio waves reaching the processing circuit board 121 from the lower imaging sensor circuit board 116e.

When viewed in the width direction A2, the first shield 122 intersects a straight line L13 extending from the upstream end of the electronic component or conductor mounted on the upper imaging sensor circuit board 116f in a direction perpendicular to the extending direction of the upper imaging sensor circuit board 116f. When viewed in the width direction A2, the first shield 122 intersects a straight line L14 extending from the downstream end of the electronic component or conductor mounted on the upper imaging sensor circuit board 116f in a direction perpendicular to the extending direction of the upper imaging sensor circuit board 116f. The straight lines L13 and L14 are examples of first and second straight lines, respectively. Thus, the first shield 122 can reduce the radio waves reaching the processing circuit board 121 from the upper imaging sensor circuit board 116f.

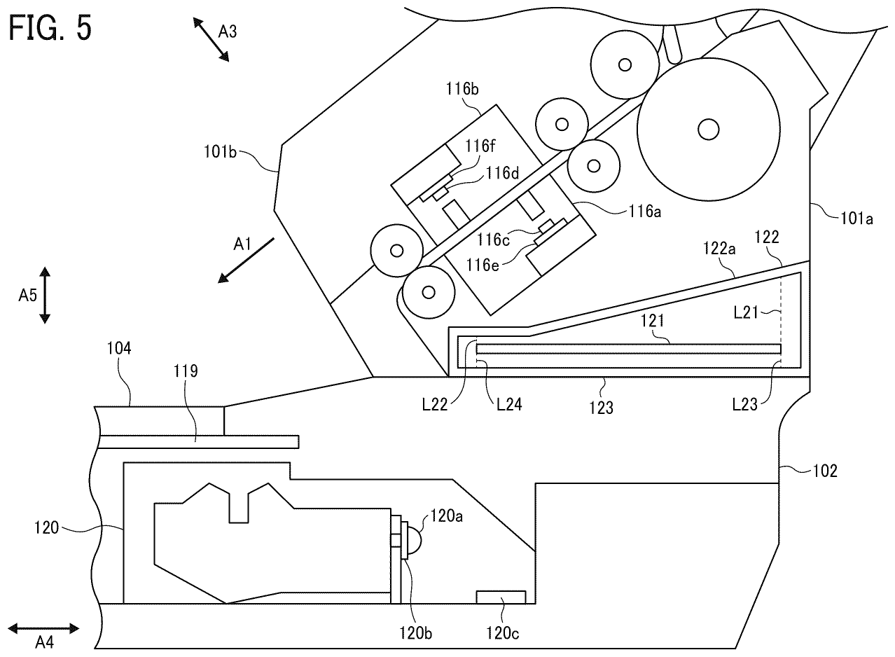

As illustrated in FIG. 5, when viewed in the width direction A2, the first shield 122 intersects a straight line L21 extending from the upstream end of the electronic component or conductor mounted on the processing circuit board 121 toward the lower imaging sensor circuit board 116e and the upper imaging sensor circuit board 116f in a direction perpendicular to the extending direction of the processing circuit board 121. When viewed in the width direction A2, the first shield 122 intersects a straight line L22 extending from the downstream end of the electronic component or conductor mounted on the processing circuit board 121 toward the lower imaging sensor circuit board 116e and the upper imaging sensor circuit board 116f in a direction perpendicular to the extending direction of the processing circuit board 121. The straight lines L21 and L22 are examples of first and second straight lines, respectively. Thus, the first shield 122 can reduce the radio waves reaching the processing circuit board 121 from the lower imaging sensor circuit board 116e and the upper imaging sensor circuit board 116f.

The first shield 122 may satisfy at least one of the arrangement conditions described above.

As described above, the medium conveying path is inclined to be higher in the vertical direction A5 on the upstream side in the medium conveying direction A1 and lower in the vertical direction A5 on the downstream side in the medium conveying direction A1. On the other hand, the processing circuit board 121 extends in parallel to the horizontal direction A4, for example. Thus, the medium conveying path is inclined such that a distance between the medium conveying path and the processing circuit board 121 increases toward the upstream position in the medium conveying direction A1 and decreases toward the downstream position in the medium conveying direction A1. A direction in which the distance between the medium conveying path and the processing circuit board 121 increases toward the upstream position in the medium conveying direction A1 and decreases toward the downstream position in the medium conveying direction A1 is an example of a predetermined direction.

The first shield 122 is inclined such that a distance between the first shield 122 and the processing circuit board 121 increases toward the upstream position in the medium conveying direction A1 and decreases toward the downstream position in the medium conveying direction A1. That is, the first shield 122 has an inclined surface 122a that is inclined in the same direction as the direction in which the medium conveying path is inclined with respect to the processing circuit board 121. The first shield 122 forms, with the processing circuit board 121, an angle that is greater than 5° and is smaller than or equal to 50°.

On the processing circuit board 121, multiple electronic components having different heights are mounted. If the first shield 122 is parallel to the processing circuit board 121, the first shield 122 is desirably separated from the processing circuit board 121 by the height of the tallest component or more from the upstream end to the downstream end of the first shield 122. On the other hand, since the upper surface of the lower housing 101a is inclined to form a straight path, the upstream portion of the upper surface of the lower housing 101a is desirably higher than the downstream portion of the upper surface of the lower housing 101a. The height of the downstream portion of the upper surface of the lower housing 101a is desirably equal to or greater than the height of the tallest component, and the height of the upstream portion of the upper surface of the lower housing 101a is desirably greater than the height of the downstream portion. Consequently, the height of the entire imaging apparatus 100 increases.

By contrast, in the imaging apparatus 100, the first shield 122 is inclined in the same direction as the direction in which the medium conveying path is inclined with respect to the processing circuit board 121. Thus, when a tall component (a first electronic component) is located on the upstream portion and a short component (a second electronic component) is located on the downstream portion of the processing circuit board 121 in the imaging apparatus 100, the height of the downstream portion of the first shield 122 can be made sufficiently small. This can make the height of the downstream portion of the lower housing 101a sufficiently small and minimize the height of the upstream portion of the lower housing 101a. Thus, the imaging apparatus 100 can have a sufficiently small height as a whole.

The second shield 123 faces the processing circuit board 121 to cover the lower surface of the processing circuit board 121. Thus, the second shield 123 shields the processing circuit board 121 to block (or attenuate) the radio waves propagating toward the processing circuit board 121 from below. The second shield 123 is formed of (composed of) a resin having a surface resistance value equal to or lower than 10¹⁰ Ω, a member coated with a conductive coating film, or a metal. The second shield 123 formed of any of such members can favorably block (or attenuate) the radio waves emitted from the second imaging sensor circuit board 120b and the interface circuit board 120c. The second shield 123 formed of a resin allows the imaging apparatus 100 to have a reduced apparatus weight and an increased design flexibility. On the other hand, the second shield 123 formed of a metal allows the imaging apparatus 100 to have a reduced surface resistance value of the second shield 123 and an enhanced radio wave blocking (or attenuating) performance.

The second shield 123 is located between the processing circuit board 121 and the second imaging sensor circuit board 120b and between the processing circuit board 121 and the interface circuit board 120c. The second shield 123 at least partially overlaps the second imaging sensor circuit board 120b or the interface circuit board 120c in the horizontal direction A4. Thus, the second shield 123 can reduce the radio waves reaching the processing circuit board 121 from the second imaging sensor circuit board 120b and the interface circuit board 120c.

As illustrated in FIG. 3, when viewed in the width direction A2, the second shield 123 intersects a straight line L5 connecting the upstream end of the electronic component or conductor mounted on the interface circuit board 120c to the upstream end of the electronic component or conductor mounted on the processing circuit board 121. When viewed in the width direction A2, the second shield 123 intersects a straight line L6 connecting the downstream end of the electronic component or conductor mounted on the interface circuit board 120c to the downstream end of the electronic component or conductor mounted on the processing circuit board 121. The straight lines L5 and L6 are examples of third and fourth straight lines, respectively. Thus, the second shield 123 can reduce the radio waves reaching the processing circuit board 121 from the interface circuit board 120c.

When viewed in the width direction A2, the second shield 123 intersects a straight line L7 connecting the lower end of the electronic component or conductor mounted on the second imaging sensor circuit board 120b to the upstream end of the electronic component or conductor mounted on the processing circuit board 121. When viewed in the width direction A2, the second shield 123 intersects a straight line L8 connecting the upper end of the electronic component or conductor mounted on the second imaging sensor circuit board 120b to the downstream end of the electronic component or conductor mounted on the processing circuit board 121. The straight lines L7 and L8 are examples of third and fourth straight lines, respectively. Thus, the second shield 123 can reduce the radio waves reaching the processing circuit board 121 from the second imaging sensor circuit board 120b.

As in the example of the straight line L1 described using FIG. 6, when viewed in the width direction A2, the straight line L5 may be set to connect the upper end or lower end of the upstream end of the electronic component or conductor mounted on the interface circuit board 120c to the lower end of the upstream end of the electronic component or conductor mounted on the processing circuit board 121. Likewise, when viewed in the width direction A2, the straight line L6 may be set to connect the upper end or lower end of the downstream end of the electronic component or conductor mounted on the interface circuit board 120c to the lower end of the downstream end of the electronic component or conductor mounted on the processing circuit board 121. Likewise, when viewed in the width direction A2, the straight line L7 may be set to connect the upstream end or downstream end of the lower end of the electronic component or conductor mounted on the second imaging sensor circuit board 120b to the lower end of the upstream end of the electronic component or conductor mounted on the processing circuit board 121. Likewise, when viewed in the width direction A2, the straight line L8 may be set to connect the upstream end or downstream end of the upper end of the electronic component or conductor mounted on the second imaging sensor circuit board 120b to the lower end of the downstream end of the electronic component or conductor mounted on the processing circuit board 121.

As illustrated in FIG. 4, when viewed in the width direction A2, the second shield 123 intersects a straight line L15 extending from the upstream end of the electronic component or conductor mounted on the interface circuit board 120c in a direction perpendicular to the extending direction of the interface circuit board 120c. When viewed in the width direction A2, the second shield 123 intersects a straight line L16 extending from the downstream end of the electronic component or conductor mounted on the interface circuit board 120c in a direction perpendicular to the extending direction of the interface circuit board 120c. The straight lines L15 and L16 are examples of third and fourth straight lines, respectively. Thus, the second shield 123 can reduce the radio waves reaching the processing circuit board 121 from the interface circuit board 120c.

When viewed in the width direction A2, the second shield 123 does not intersect a straight line L17 extending from the lower end of the electronic component or conductor mounted on the second imaging sensor circuit board 120b in a direction perpendicular to the extending direction of the second imaging sensor circuit board 120b. When viewed in the width direction A2, the second shield 123 does not intersect a straight line L18 extending from the upper end of the electronic component or conductor mounted on the second imaging sensor circuit board 120b in a direction perpendicular to the extending direction of the second imaging sensor circuit board 120b. Since neither the straight line L17 nor the straight line L18 intersects the processing circuit board 121, the second shield 123 can reduce the radio waves reaching the processing circuit board 121 from the second imaging sensor circuit board 120b even when the second shield 123 intersects neither the straight line L17 nor the straight line L18.

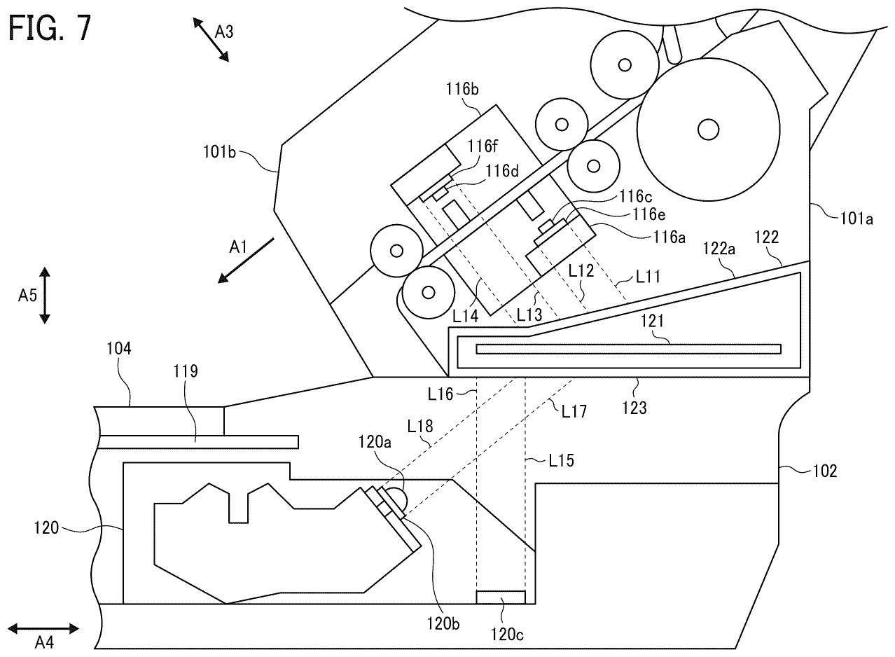

FIG. 7 is a schematic diagram illustrating another structure of the second imaging device 120.

The extending direction of the second imaging sensor circuit board 120b of the second imaging device 120 illustrated in FIG. 7 is inclined with respect to the vertical direction A5. When viewed in the width direction A2, the second shield 123 intersects the straight line L17 extending from the upstream end of the electronic component or conductor mounted on the second imaging sensor circuit board 120b in a direction perpendicular to the extending direction of the second imaging sensor circuit board 120b. When viewed in the width direction A2, the second shield 123 intersects the straight line L18 extending from the downstream end of the electronic component or conductor mounted on the second imaging sensor circuit board 120b in a direction perpendicular to the extending direction of the second imaging sensor circuit board 120b. The straight lines L17 and L18 are examples of third and fourth straight lines, respectively. Thus, the second shield 123 can reduce the radio waves reaching the processing circuit board 121 from the second imaging sensor circuit board 120b.

As illustrated in FIG. 5, when viewed in the width direction A2, the second shield 123 intersects a straight line L23 extending from the upstream end of the electronic component or conductor mounted on the processing circuit board 121 toward the interface circuit board 120c and the second imaging sensor circuit board 120b in a direction perpendicular to the extending direction of the processing circuit board 121. When viewed in the width direction A2, the second shield 123 intersects a straight line L24 extending from the downstream end of the electronic component or conductor mounted on the processing circuit board 121 toward the interface circuit board 120c and the second imaging sensor circuit board 120b in a direction perpendicular to the extending direction of the processing circuit board 121. The straight lines L23 and L24 are examples of third and fourth straight lines, respectively. Thus, the second shield 123 can reduce the radio waves reaching the processing circuit board 121 from the second imaging sensor circuit board 120b and the interface circuit board 120c.

The second shield 123 may satisfy at least one of the arrangement conditions described above.

The second shield 123 is substantially parallel to the processing circuit board 121. The state of being substantially parallel includes not only the state of being completely parallel but also the state of forming a predetermined angle (e.g., 5 degrees) or smaller.

As described above, tall components are located on the upstream portion of the upper surface of the processing circuit board 121 and short components are mounted on the lower surface of the processing circuit board 121. This can make the distance between the processing circuit board 121 and the bottom surface of the first housing 101 sufficiently small and allows the imaging apparatus 100 to have a sufficiently small height as a whole.

The processing circuit board 121 is substantially parallel to the second shield 123. This allows the imaging apparatus 100 to have a radio wave effect caused by parallel plate resonance and reduce the influence of the radio wave.

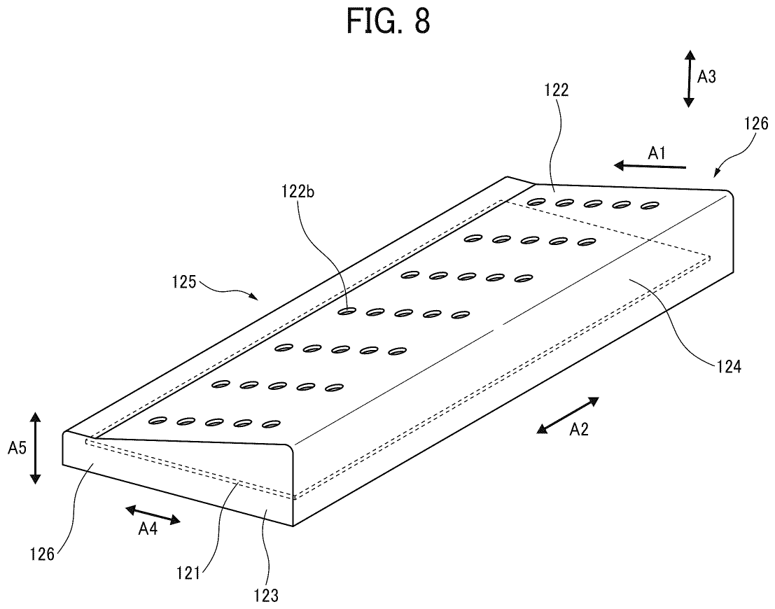

FIG. 8 is a perspective view of the processing circuit board 121, the first shield 122, and the second shield 123 viewed from above on the upstream side.

As illustrated in FIG. 8, the first shield 122 covers the upper surface of the processing circuit board 121 across the processing circuit board 121 in the width direction A2. The second shield 123 covers the lower surface of the processing circuit board 121 across the processing circuit board 121 in the width direction A2. The first shield 122 may have one or more holes 122b. Likewise, the second shield 123 may have one or more holes. This allows the imaging apparatus 100 to release the heat produced by the processing circuit board 121 from an area surrounded by the first shield 122 and the second shield 123, and thus prevent the heat-induced malfunction from occurring.

The imaging apparatus 100 further includes an upstream shield 124, a downstream shield 125, and side shields 126. The upstream shield 124 covers the upstream portion of the processing circuit board 121 to shield the processing circuit board 121 and block (or attenuate) the radio waves propagating toward the processing circuit board 121 from upstream. The downstream shield 125 covers the downstream portion of the processing circuit board 121 to shield the processing circuit board 121 and block (or attenuate) the radio waves propagating toward the processing circuit board 121 from downstream. The side shields 126 cover the respective ends of the processing circuit board 121 in the width direction A2 to shield the processing circuit board 121 and block (or attenuate) the radio waves propagating toward the processing circuit board 121 from the respective sides. The upstream shield 124, the downstream shield 125, and/or the side shields 126 are/is formed of a resin having a surface resistance value equal to or lower than 10¹⁰ Ω, a member coated with a conductive coating film, or a metal. The upstream shield 124, the downstream shield 125, and/or the side shields 126 may have holes or gaps for releasing the heat produced by the processing circuit board 121. The upstream shield 124, the downstream shield 125, and/or the side shields 126 may be omitted.

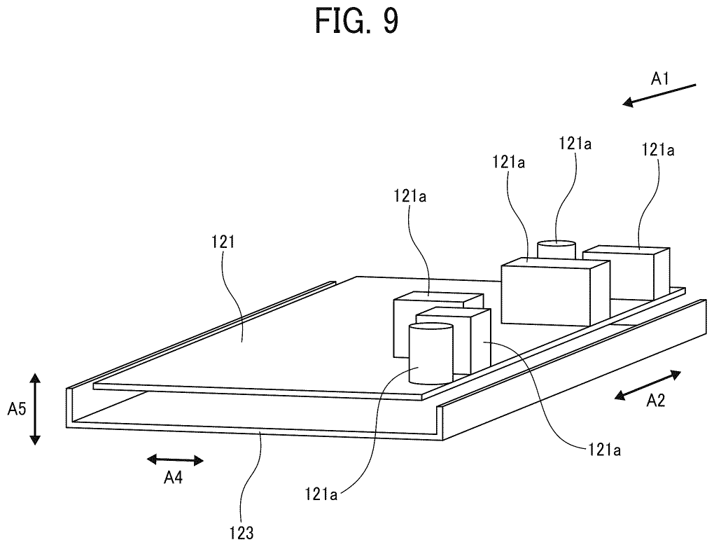

FIG. 9 is a perspective view of the processing circuit board 121, from which the first shield 122 is removed, viewed from the side.

The processing circuit board 121 has various circuit components mounted thereon. Among such components mounted on the processing circuit board 121, components 121a having a predetermined height or greater, such as a connector and a capacitor, are located on the upstream portion of the upper surface of the processing circuit board 121. The components 121a are located in an area of the processing circuit board 121 where the distance between the processing circuit board 121 and the first shield 122 is a predetermined distance or greater. The predetermined height is set to a height (e.g., 1 cm) that is higher than the height of ICs or LSI chips commonly used. The predetermined distance is set to a length obtained by adding a margin (e.g., 1 cm) to the height of the components 121a. On the other hand, components having heights smaller than the predetermined height are located on the downstream portion of the upper surface of the processing circuit board 121 and on the lower surface of the processing circuit board 121. For example, a first reception circuit (described later) that receives the first media signal from the first media sensor 110 and/or a second reception circuit (described later) that receives the second media signal from the second media sensor 115 are located on the lower surface of the processing circuit board 121, i.e., the surface of the processing circuit board 121 adjacent to the second shield 123. The circuits that process the first media signal and the second media signal and are prone to receive the influence of the radio waves are located on the lower surface of the processing circuit board 121. This allows the imaging apparatus 100 to prevent the malfunction from occurring.

As described above, the first shield 122 is inclined in the same direction as the direction in which the medium conveying path is inclined with respect to the processing circuit board 121. The first shield 122 is inclined to minimize the space between the processing circuit board 121 and the first shield 122 while allowing components to be mounted on the processing circuit board 121. The first shield 122 is inclined to minimize the sum of distances between the first shield 122 and the upper surfaces of the components mounted on the processing circuit board 121. This allows the components 121a having the predetermined height or greater to be located on the upstream portion of the upper surface of the processing circuit board 121, and allows the imaging apparatus 100 to efficiently use the space inside the lower housing 101a and have a reduced height as a whole. The components having heights smaller than the predetermined height are located on the lower surface of the processing circuit board 121. This can reduce the distance between the processing circuit board 121 and the bottom surface of the lower housing 101a and allows the imaging apparatus 100 to have a reduced height as a whole.

The first shield 122 is located to minimize the space between the processing circuit board 121 and the first shield 122. This allows the imaging apparatus 100 to prevent or reduce the occurrence of the cavity resonance and reduce the influence of the radio waves.

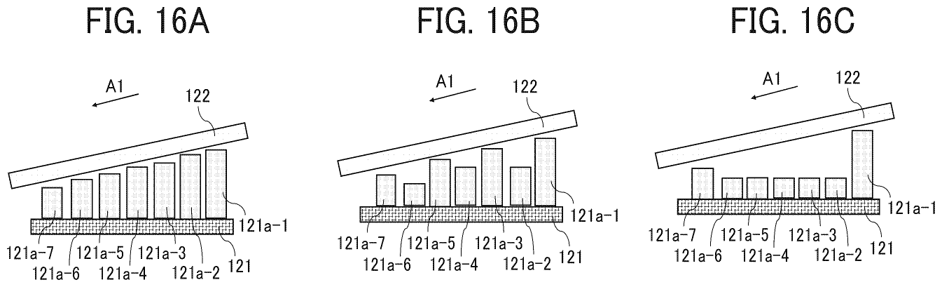

FIGS. 16A, 16B, and 16C are schematic diagrams each illustrating an arrangement of electronic components having different height on the processing circuit board 121, as viewed from a direction intersecting the medium conveying direction A1.

FIGS. 16A, 16B, and 16C illustrate examples of the arrangement of electronic components 121a-1 to 121a-7 in which electronic components having larger heights are mounted in an upstream portion of the processing circuit board 121 located below an upstream position in the medium conveying direction A1, and electronic components having smaller height are mounted in a downstream portion of the processing circuit board 121 located below a downstream position in the medium conveying direction A1.

Compared to other drawings such as FIG. 3, the angle of the medium conveying direction A1 in FIGS. 16A to 16C relative to the installation surface on which the imaging apparatus 100 is installed is gentler and substantially parallel to the first shield 122. The medium conveying direction A1 and the first shield 122 are inclined to the same direction, but the medium conveying direction A1 needs not to be substantially parallel to the first shield 122.

In FIG. 16A, in the medium conveying direction A1, the electronic component 121a-1 having the largest height is extreme upstream among the electronic components 121a-1 to 121a-7, the electronic components 121a-2 to 121a-6 are arranged in the descending order of height toward the downstream side, and the electronic component 121a-7 having the smallest height is extreme downstream among the electronic components 121a-1 to 121a-7.

In FIG. 16B, the electronic component 121a-1 having the largest height is extreme upstream, and the electronic components 121a-2 to 121a-7 smaller in height than the electronic component 121a-1 are downstream from the electronic component 121a-1. The electronic components 121a-2 to 121a-7, which are different in height, are not necessarily arranged in order of height.

In FIG. 16C, the electronic component 121a-1 having the largest height is extreme upstream, and the electronic component 121a-7 having a relatively small height is extreme downstream. The electronic components 121 a-2 to 121a-6 located therebetween are smaller in height than the electronic components 121a-1 and 121a-7.

The electronic component located extreme upstream in the medium conveying direction A1 is not necessarily the highest one of the multiple electronic components. The number of electronic components is not limited to the illustrated examples, and any desired number of electronic components can be mounted.

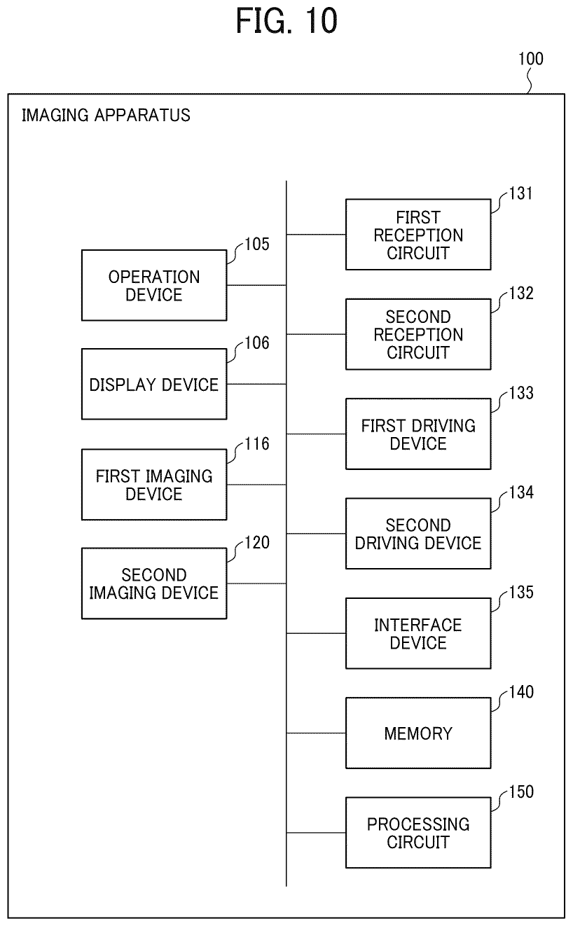

FIG. 10 is a block diagram illustrating a schematic configuration of the imaging apparatus 100.

In addition to the configuration described above, the imaging apparatus 100 further includes a first reception circuit 131, a second reception circuit 132, a first driving device 133, a second driving device 134, an interface device 135, a memory 140, and a processing circuit 150.

The first reception circuit 131 includes an A/D converter that amplifies an analog electrical signal and performs A/D conversion. The first reception circuit 131 receives the analog first media signal output from the first media sensor 110, converts the received first media signal into a digital signal, and outputs the digital signal to the processing circuit 150.

The second reception circuit 132 includes an A/D converter that amplifies an analog electrical signal and performs A/D conversion. The second reception circuit 132 receives the analog second media signal output from the second media sensor 115, converts the received second media signal into a digital signal, and outputs the digital signal to the processing circuit 150.

The first driving device 133 is an example of a driver. The first driving device 133 includes one or more motors. The first driving device 133 generates a driving force for rotating the feed roller 111, the separation roller 112, the first conveyance roller 113, the second conveyance roller 114, the first ejection roller 117, and/or the second ejection roller 118 in accordance with a control signal from the processing circuit 150. The first driving device 133 is, for example, a direct-current (DC) motor. The first driving device 133 may be a stepping motor. The second conveyance roller 114 and/or the second ejection roller 118 may be driven rollers rotated by the first conveyance roller 113 and the first ejection roller 117, respectively. Alternatively, the first conveyance roller 113 and/or the first ejection roller 117 may be driven rollers rotated by the second conveyance roller 114 and the second ejection roller 118, respectively.

The second driving device 134 is an example of a driver. The second driving device 134 includes one or more motors. The second driving device 134 generates a driving force for horizontally moving the second imaging device 120 in accordance with a control signal from the processing circuit 150. The second driving device 134 is, for example, a DC motor. The second driving device 134 may be a stepping motor.

The interface device 135 is an example of a communication device. The interface device 135 includes, for example, an interface circuit compatible with a serial bus such as a Universal Serial Bus (USB). The interface device 135 is electrically connected to an external information processing apparatus (e.g., a personal computer or mobile information terminal) and transmits and receives the first input image, the second input image, and various kinds of information. The interface device 135 includes an antenna that transmits and receives wireless signals, and a wireless communication interface circuit that transmits and receives signals through a wireless communication line in compliance with a given communication protocol. The given communication protocol is, for example, a wireless local area network (LAN) communication protocol. The interface device 135 may include a wired communication interface circuit that transmits and receives signals through a wired communication line in compliance with a wired LAN communication protocol.

The memory 140 includes memory devices such as a RAM and a ROM; a fixed disk device such as a hard disk; or a portable storage device such as a flexible disk or an optical disk. The memory 140 stores, for example, computer programs, databases, and tables used for various processes performed by the imaging apparatus 100. The computer programs may be installed into the memory 140 from a computer-readable portable recording medium using a known setup program, for example. The portable recording medium is, for example, a compact disc-read-only memory (CD-ROM) or a digital versatile disc read-only memory (DVD-ROM). The computer programs may be distributed from, for example, a server and installed into the memory 140.

The processing circuit 150 operates according to a program prestored in the memory 140. The processing circuit 150 is, for example, a CPU. Alternatively, a digital signal processor (DSP), an LSI, an application-specific integrated circuit (ASIC), a field-programmable gate array (FPGA), etc. may be used as the processing circuit 150.

The processing circuit 150 is connected to and controls the operation device 105, the display device 106, the first imaging device 116, the second imaging device 120, the first reception circuit 131, the second reception circuit 132, the first driving device 133, the second driving device 134, the interface device 135, and the memory 140. The processing circuit 150 performs driving control on the first and second driving devices 133 and 134, and imaging control on the first and second imaging devices 116 and 120, based on the operation signal received from the operation device 105 or the interface device 135 and/or the first and second media signals received from the first and second reception circuits 131 and 132. The processing circuit 150 obtains the first and second input images from the first and second imaging devices 116 and 120, and transmits the first and second input images to the information processing apparatus via the interface device 135.

The first reception circuit 131, the second reception circuit 132, the interface device 135, the memory 140, and/or the processing circuit 150 are mounted on the processing circuit board 121. The first reception circuit 131, the second reception circuit 132, the interface device 135, the memory 140, and/or the processing circuit 150 are mounted on the lower surface of the processing circuit board 121 or on the downstream portion of the upper surface of the processing circuit board 121. The connector connected to the interface device 135 is mounted on the upstream portion of the upper surface of the processing circuit board 121.

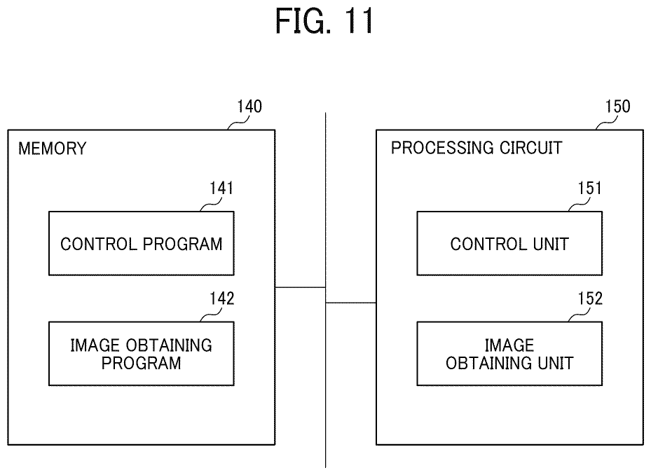

FIG. 11 is a block diagram illustrating a schematic configuration of the memory 140 and the processing circuit 150.

As illustrated in FIG. 11, the memory 140 stores a control program 141 and an image obtaining program 142. These programs are functional modules implemented by software to operate on the processor. The processing circuit 150 reads each program stored in the memory 140 and operates in accordance with the read program. Thus, the processing circuit 150 functions as a control unit 151 and an image obtaining unit 152.

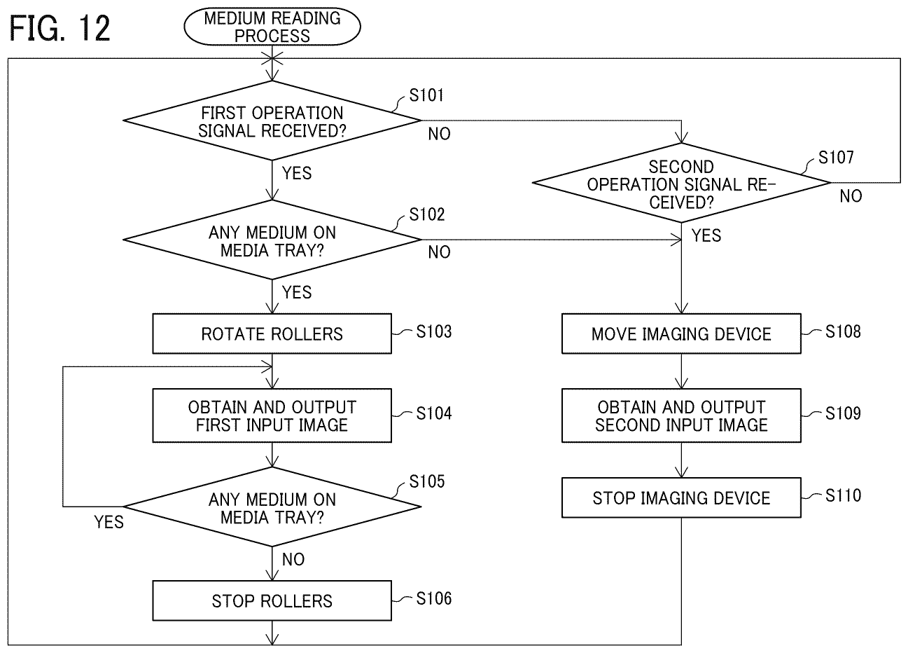

FIG. 12 is a flowchart of a medium reading process performed by the imaging apparatus 100.

The example operation of the medium reading process performed by the imaging apparatus 100 is described below with reference to the flowchart in FIG. 12. The operation sequence described below is performed, for example, by the processing circuit 150 in cooperation with the components of the imaging apparatus 100 based on the programs prestored in the memory 140.

First, the control unit 151 determines whether a first operation signal that instructs reading of a medium using the ADF is received in step S101. The control unit 151 determines whether the first operation signal is received from the operation device 105 or the interface device 135 in response to a user inputting, with the operation device 105 or an information processing apparatus, the instruction for reading a medium using the ADF.

When the first operation signal is received (Yes in S101), the control unit 151 obtains a first media signal from the first reception circuit 131, and determines whether a medium is placed on the first media tray 103 based on the obtained first media signal in step S102. When no medium is placed on the first media tray 103 (No in S102), the control unit 151 causes the process to proceed to step S108. In this case, as described later, the control unit 151 causes the second imaging device 120 to image a medium placed on the second media tray 119, and the image obtaining unit 152 obtains a second input image from the second imaging device 120.

When a medium or media are placed on the first media tray 103 (Yes in step S102), the control unit 151 controls the first driving device 133 to rotate the rollers to convey the medium or media in step S103. The control unit 151 drives the first driving device 133 to rotate the feed roller 111, the separation roller 112, the first conveyance roller 113, the second conveyance roller 114, the first ejection roller 117, and/or the second ejection roller 118.

The first imaging device 116 images each medium to generate a first input image, and the image obtaining unit 152 obtains the first input image from the first imaging device 116. The image obtaining unit 152 transmits (i.e., outputs) the obtained first input image to the information processing apparatus via the interface device 135 in step S104. The image obtaining unit 152 regularly obtains a second media signal from the second reception circuit 132. The image obtaining unit 152 determines that the leading end of the medium has passed the position of the second media sensor 115 in response to a change in the signal value of the second media signal from the value indicating the absence of a medium to the value indicating the presence of a medium, and the first imaging device 116 starts imaging the medium. The image obtaining unit 152 determines that the trailing end of the medium has passed the position of the second media sensor 115 in response to a change in the signal value of the second media signal from the value indicating the presence of a medium to the value indicating the absence of a medium. The first imaging device 116 ends imaging of the medium in response to an elapse of a predetermined period since it is determined by the image obtaining unit 152 that the trailing end of the medium has passed the position of the second media sensor 115. The predetermined period is set to the time for the medium to move from the position of the second media sensor 115 to the imaging position of the first imaging device 116.

The control unit 151 obtains the first media signal from the first reception circuit 131, and determines whether a medium remains on the first media tray 103 based on the obtained first media signal in step S105. When a medium remains on the first media tray 103 (Yes in S105), the control unit 151 returns the process to step S104, and the processing is repeated from step S104.

When no medium remains on the first media tray 103 (No in S105), the control unit 151 controls the first driving device 133 to stop the rollers in step S106. The process then returns to step S101. The control unit 151 stops the first driving device 133 to stop the separation roller 112, the first conveyance roller 113, the second conveyance roller 114, the first ejection roller 117, and/or the second ejection roller 118.

When no first operation signal is received (No in S101), the control unit 151 determines whether a second operation signal that instructs reading of a medium using the flatbed is received in step S107. The control unit 151 determines whether the second operation signal is received from the operation device 105 or the interface device 135 in response to a user inputting, with the operation device 105 or an information processing apparatus, the instruction for reading a medium using the flatbed.

When the second operation signal is received from the operation device 105 (Yes in S107) or when no medium is placed on the first media tray 103 (No in S102), the control unit 151 controls the second driving device 134 to move the second imaging device 120 in the sub-scanning direction in step S108. The control unit 151 drives the second driving device 134 to move the second imaging device 120 from the initial position (left end position in FIG. 2) to the imaging end position (position where the second imaging device 120 is located in FIG. 2).

The second imaging device 120 images the medium placed on the second media tray 119 to generate a second input image, and the image obtaining unit 152 obtains the second input image from the second imaging device 120. The image obtaining unit 152 transmits (i.e., outputs) the obtained second input image to the information processing apparatus via the interface device 135 in step S109.

The control unit 151 controls the second driving device 134 to return the second imaging device 120 to the initial position and stop the second imaging device 120 in step S110. The process then returns to step S101. The control unit 151 drives the second driving device 134 to move the second imaging device 120 from the imaging end position to the initial position, and stops the second driving device 134 to stop the second imaging device 120.

When no medium is placed on the first media tray 103 (No in S102), the control unit 151 may skip imaging of the medium and cause the process to return to step S101.

As described in detail above, the imaging apparatus 100 includes the first shield 122 located between the first radio wave generation source and the processing circuit board 121 and the second shield 123 located between the second radio wave generation source and the processing circuit board 121. The first shield 122 has the inclined surface 122a that is inclined in the same direction as the direction in which the medium conveying path is inclined with respect to the processing circuit board 121. This allows the components 121a having the predetermined height or greater to be located on the upstream portion of the upper surface of the processing circuit board 121, and allows the imaging apparatus 100 to efficiently use the internal space thereof and have a reduced height as a whole.

Thus, the imaging apparatus 100 can reduce the influence of a radio wave generated by each radio wave generation source without increases in the apparatus size.

Desirably, imaging apparatus or medium conveying apparatuses have various functions such as the functions of detecting conveyance abnormalities, such as medium skewing, paper jamming, and multi-feed, and correcting the skewing of the medium. To implement these functions, the imaging apparatus 100 has many components mounted on the processing circuit board 121. Consequently, the size of the processing circuit board 121 is increasing. However, the imaging apparatus 100 having a so-called straight path mechanism is made compact. This makes it difficult to dispose the processing circuit board 121 in the imaging apparatus 100 to be immune to the influence of the radio waves from each radio wave generation source. In the imaging apparatus 100, however, the first shield 122 and the second shield 123 are located between the processing circuit board 121 and the respective radio wave generation sources. This reduces the influence of the radio wave from each radio wave generation source on the processing circuit board 121. Further, the first shield 122 is inclined in the same direction as the direction in which the medium conveying path is inclined with respect to the processing circuit board 121. Thus, the imaging apparatus 100 can reduce the influence of a radio wave generated by each radio wave generation source without increases in the apparatus size.

The imaging apparatus 100 can prevent the malfunctions caused by the radio waves emitted from the imaging sensors or the circuit boards on which the imaging sensors are mounted, while supporting both ADF imaging and flatbed imaging.

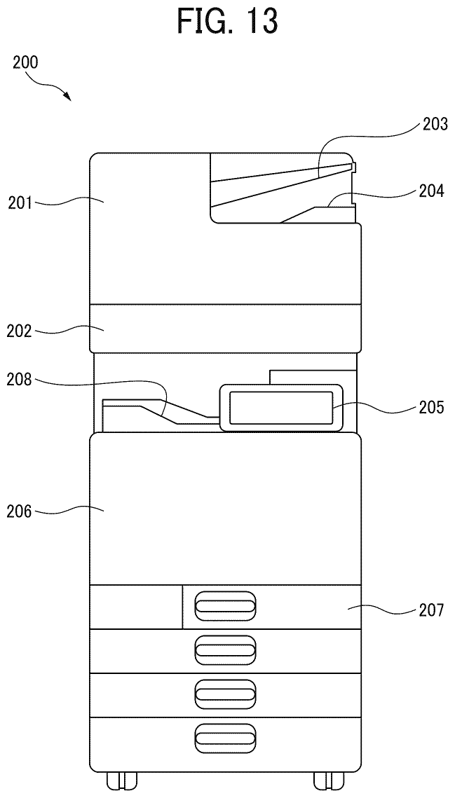

FIG. 13 is a schematic diagram illustrating another imaging apparatus.

An imaging apparatus 200 has the function of forming an image on the medium, which is a recording sheet, while conveying the medium in addition to the functions of imaging a medium (a document) while conveying the medium and imaging a medium (a document) placed on a transparent receiving surface without conveying the medium. The imaging apparatus 200 may be, for example, a copier or a multifunction peripheral (MFP).

The imaging apparatus 200 includes a first housing 201, a second housing 202, a first media tray 203, a first ejection tray 204, an operation display device 205, a third housing 206, a third media tray 207, and a third ejection tray 208.

The first housing 201 and components located in the first housing 201 are an example of the automatic document feeder as well as the scanner, and perform ADF imaging in which a medium is imaged while being conveyed. The second housing 202 and components located in the second housing 202 function as an example of the flatbed section as well as an example of the scanner, and perform flatbed imaging in which a medium placed on a transparent receiving surface is imaged without being conveyed. The third housing 206 and components located in the third housing 206 are an example of the automatic document feeder as well as an example of a printer, perform image formation on a medium while conveying the medium.

The first housing 201 is located above the second housing 202. The second housing 202 is located above the third housing 206. The first housing 201 is engaged by hinges with the second housing 202 such that the first housing 201 is opened and closed relative to the second housing 202. When the first housing 201 is closed relative to the second housing 202, the first housing 201 covers the upper surface of the second housing 202. When the first housing 201 is opened relative to the second housing 202, the upper surface of the second housing 202 is exposed to allow a user to place a medium on the upper surface of the second housing 202.

The first media tray 203 is engaged with the first housing 201 to support a medium to be conveyed in the first housing 201. The first ejection tray 204 is engaged with the first housing 201 to support a medium ejected from the first housing 201.

The operation display device 205 may include an output device, such as a liquid crystal display or organic electro-luminescence (EL) display, and an interface circuit that outputs image data to the output device. The operation display device 205 displays a predetermined image in accordance with an instruction from a processing circuit. The operation display device 205 includes an input device, such as a touch panel, and an interface circuit that obtains signals from the input device. The operation display device 205 receives an operation input by the user and outputs a signal corresponding to the operation input by the user. The operation display device 205 is provided on the third housing 206, that is, located below the first housing 201 and the second housing 202. The operation display device 205 includes an operation display device circuit board. The operation display device circuit board is a printed circuit board on which electronic components and/or conductors, including the aforementioned interface circuit, are mounted. The electronic components and/or conductors mounted on the operation display device circuit board are each an example of the second radio wave generation source, and generate a predetermined radio wave.

The third media tray 207 is drawable from the third housing 206 and supports (stores) media to be conveyed in the third housing 206. The third ejection tray 208 is engaged with the third housing 206 to support a medium ejected from the third housing 206.

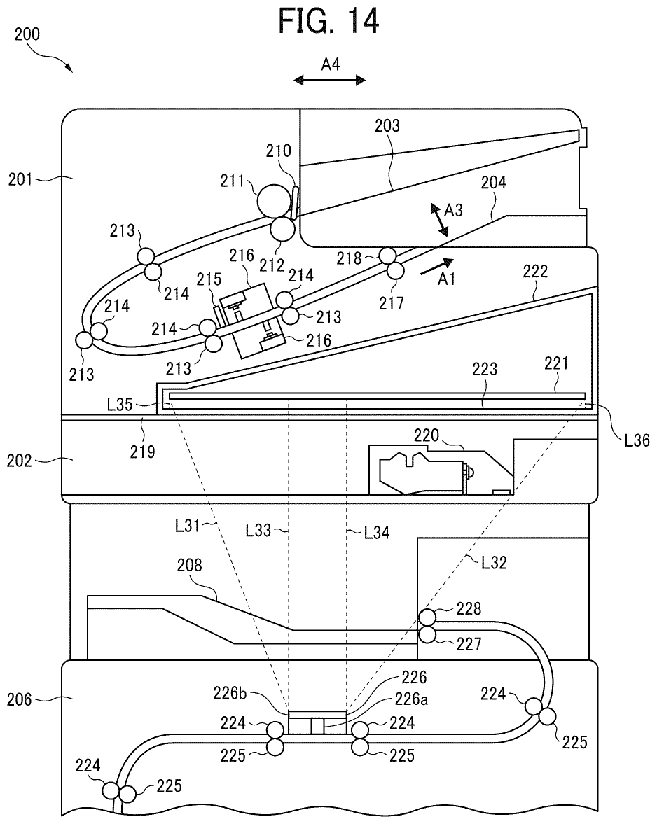

FIG. 14 is a diagram illustrating a structure inside the imaging apparatus 200.

The imaging apparatus 200 includes a first media sensor 210, a feed roller 211, a separation roller 212, first conveyance rollers 213, second conveyance rollers 214, a second media sensor 215, a first imaging device 216, a first ejection roller 217, a second ejection roller 218, a second media tray 219, a second imaging device 220, a processing circuit board 221, a first shield 222, a second shield 223, third conveyance rollers 224, fourth conveyance rollers 225, a printer 226, a third ejection roller 227, and a fourth ejection roller 228. The first media sensor 210, the feed roller 211, the separation roller 212, the first conveyance rollers 213, the second conveyance rollers 214, the second media sensor 215, the first imaging device 216, the first ejection roller 217, the second ejection roller 218, the processing circuit board 221, the first shield 222, and the second shield 223 are located in the first housing 201. The second media tray 219 and the second imaging device 220 are located in the second housing 202. The third conveyance rollers 224, the fourth conveyance rollers 225, the printer 226, the third ejection roller 227, and the fourth ejection roller 228 are located in the third housing 206.

A medium conveying path is located in the first housing 201. As illustrated in FIG. 14, the medium conveying path has a so-called U-turn path mechanism in which the vertical relative positions of the front side and the back side of a medium change when the medium is placed on the first media tray 203 before being conveyed and when the medium is placed on the first ejection tray 204 after being ejected. A portion of the medium conveying path near the first imaging device 216 is inclined to be lower in the height direction A3 on the upstream side in the medium conveying direction A1 and higher in the height direction A3 on the downstream side in the medium conveying direction A1.

The first media sensor 210, the feed roller 211, the separation roller 212, the first conveyance rollers 213, the second conveyance rollers 214, the second media sensor 215, the first imaging device 216, the first ejection roller 217, the second ejection roller 218, the second media tray 219, the second imaging device 220, the processing circuit board 221, the first shield 222, and the second shield 223 have functions and structures similar to those of the first media sensor 110, the feed roller 111, the separation roller 112, the first conveyance roller 113, the second conveyance roller 114, the second media sensor 115, the first imaging device 116, the first ejection roller 117, the second ejection roller 118, the second media tray 119, the second imaging device 120, the processing circuit board 121, the first shield 122, and the second shield 123 of the imaging apparatus 100, respectively.

The feed roller 211 is located above the separation roller 212 and separates and feeds the media placed on the first media tray 203 sequentially from the top. Multiple first conveyance rollers 213 and multiple second conveyance rollers 214 are provided along the medium conveying direction A1.

A medium conveying path is located in the third housing 206. As illustrated in FIG. 14, the medium conveying path has a so-called U-turn path mechanism in which the vertical relative positions of the front side and the back side of a medium change when the medium is placed on the third media tray 207 before being conveyed and when the medium is placed on the third ejection tray 208 after being ejected.

The third conveyance rollers 224 and the fourth conveyance rollers 225 are an example of a conveyor. The third conveyance rollers 224 and the fourth conveyance rollers 225 face each other and convey a medium to the printer 226.

The printer 226 is an example of a printer. The printer 226 prints information on a medium conveyed by the third conveyance rollers 224 and the fourth conveyance rollers 225. The printer 226 prints an image designated by the user using the operation display device 205 or an image read by the first imaging device 216 or the second imaging device 220. The printer 226 includes an image forming circuit board 226b and an image forming device mounted thereon. The image forming device 226a is, for example, an inkjet printer including an inkjet print head having multiple ink ejection ports. The image forming device 226a ejects ink onto a medium passing the position of the printer 226 to print predetermined information on the medium. The image forming device 226a may be a printing device for a printer other than the inkjet printer, such as a laser printer. The image forming circuit board 226b is a printed circuit board on which electronic components including the image forming device 226a or an image forming conductor (e.g., a wiring pattern for image formation), are mounted.

The image forming device 226a is an example of an image forming electronic component and included in a printer. The image forming electronic components and/or the image forming conductor mounted on the image forming circuit board 226b are each an example of a second radio wave generation source and generate a predetermined radio wave.

The third ejection roller 227 and the fourth ejection roller 228 are an example of an ejector. The third ejection roller 227 and the fourth ejection roller 228 face each other, and eject, onto the third ejection tray 208, the medium that is conveyed by the third conveyance rollers 224 and the fourth conveyance rollers 225 and has thereon an image formed by the printer 226.

The processing circuit board 221 at least partially overlaps the image forming circuit board 226b or the operation display device circuit board in the horizontal direction A4.

The second shield 223 is located between the processing circuit board 221 and the second imaging sensor circuit board and between the processing circuit board 221 and the interface circuit board, and between the processing circuit board 221 and the image forming circuit board 226b and between the processing circuit board 221 and the operation display device circuit board. The second shield 223 at least partially overlaps the image forming circuit board 226b or the operation display device circuit board in the horizontal direction A4. Thus, the second shield 223 can favorably reduce the radio waves reaching the processing circuit board 221 from the image forming circuit board 226b and the operation display device circuit board.

When viewed in a width direction intersecting the medium conveying direction A1, the second shield 223 intersects a straight line L31 connecting the left end of the electronic component or conductor mounted on the image forming circuit board 226b in FIG. 14 to the left end of the electronic component or conductor mounted on the processing circuit board 221. When viewed in the width direction, the second shield 223 intersects a straight line L32 connecting the right end of the electronic component or conductor mounted on the image forming circuit board 226b to the right end of the electronic component or conductor mounted on the processing circuit board 221. The straight lines L31 and L32 are examples of third and fourth straight lines, respectively. Thus, the second shield 223 can reduce the radio waves reaching the processing circuit board 221 from the image forming circuit board 226b.

Likewise, when viewed in the width direction, the second shield 223 intersects a straight line connecting the left end of the electronic component or conductor mounted on the operation display device circuit board to the left end of the electronic component or conductor mounted on the processing circuit board 221. When viewed in the width direction, the second shield 223 intersects a straight line connecting the right end of the electronic component or conductor mounted on the operation display device circuit board to the right end of the electronic component or conductor mounted on the processing circuit board 221. These straight lines are examples of third and fourth straight lines. Thus, the second shield 223 can reduce the radio waves reaching the processing circuit board 221 from the operation display device circuit board.

When viewed in the width direction, the second shield 223 intersects a straight line L33 extending from the left end of the electronic component or conductor mounted on the image forming circuit board 226b in a direction perpendicular to the extending direction of the image forming circuit board 226b. When viewed in the width direction, the second shield 223 intersects a straight line L34 extending from the right end of the electronic component or conductor mounted on the image forming circuit board 226b in a direction perpendicular to the extending direction of the image forming circuit board 226b. The straight lines L33 and L34 are examples of third and fourth straight lines, respectively. Thus, the second shield 223 can reduce the radio waves reaching the processing circuit board 221 from the image forming circuit board 226b.

Likewise, when viewed in the width direction, the second shield 223 intersects a straight line extending from the left end of the electronic component or conductor mounted on the operation display device circuit board in a direction perpendicular to the extending direction of the operation display device circuit board. When viewed in the width direction, the second shield 223 intersects a straight line extending from the right end of the electronic component or conductor mounted on the operation display device circuit board in a direction perpendicular to the extending direction of the operation display device circuit board. These straight lines are examples of third and fourth straight lines. Thus, the second shield 223 can reduce the radio waves reaching the processing circuit board 221 from the operation display device circuit board.

When viewed in the width direction, the second shield 223 intersects a straight line L35 extending from the left end of the electronic component or conductor mounted on the processing circuit board 221 toward the image forming circuit board 226b and the operation display device circuit board in a direction perpendicular to the extending direction of the processing circuit board 221. When viewed in the width direction, the second shield 223 intersects a straight line L36 extending from the right end of the electronic component or conductor mounted on the processing circuit board 221 toward the image forming circuit board 226b and the operation display device circuit board in a direction perpendicular to the extending direction of the processing circuit board 221. The straight lines L35 and L36 are examples of third and fourth straight lines, respectively. Thus, the second shield 223 can reduce the radio waves reaching the processing circuit board 221 from the image forming circuit board 226b and the operation display device circuit board.

The second shield 223 may satisfy at least one of the arrangement conditions described above.

The imaging apparatus 200 includes the components included in the imaging apparatus 100 illustrated in FIG. 10 and performs the medium reading process illustrated in FIG. 12. The imaging apparatus 200 further includes a third driving device that generates a driving force for rotating the third conveyance rollers 224, the fourth conveyance rollers 225, the third ejection roller 227, and the fourth ejection roller 228. When the control unit of the imaging apparatus 200 receives a third operation signal for instructing printing from the operation display device 205, the control unit controls the third driving device to rotate the third conveyance rollers 224, the fourth conveyance rollers 225, the third ejection roller 227, and the fourth ejection roller 228. When the user inputs an instruction for printing with the operation display device 205 or an information processing apparatus, the control unit receives the third operation signal from the operation display device 205 or the interface device. The control unit controls the printer 226 to perform printing in accordance with settings designated by the user.

The second housing 202 may be omitted from the imaging apparatus 200, and the imaging apparatus 200 may include no flatbed section.

The imaging apparatus 200 including a printer can reduce the influence of a radio wave generated by the radio wave generation sources without increases in the apparatus size as described above in detail.

The imaging apparatus 200 can also prevent the malfunction from occurring owing to the radio waves emitted from the imaging sensors, the circuit board on which the imaging sensors are mounted, the printer, and the circuit board on which the printer is mounted, while supporting both imaging of a medium and image formation on a medium.

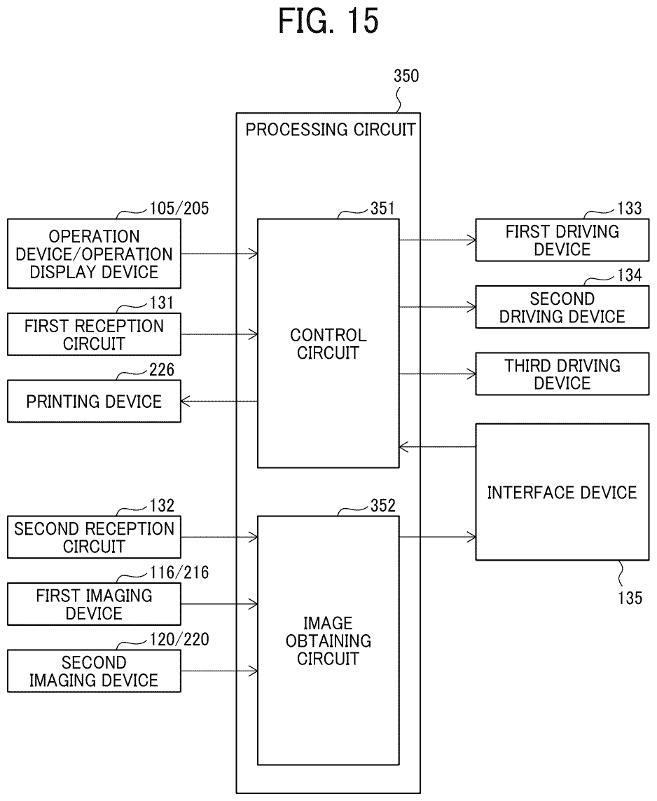

FIG. 15 is a block diagram illustrating a schematic configuration of a processing circuit of another imaging apparatus.

A processing circuit 350 is used in place of the processing circuit 150 and performs the medium reading process, etc., in place of the processing circuit 150. The processing circuit 350 includes a control circuit 351 and an image obtaining circuit 352. These circuits may be implemented by independent integrated circuits, microprocessors, firmware, or the like.

The control circuit 351 is an example of a controller and has substantially the same functions as the control unit 151. The control circuit 351 receives operation signals from the operation device 105, the operation display device 205, or the interface device 135. The control circuit 351 also receives the first media signal from the first reception circuit 131. Based on each received signal, the control circuit 351 controls the first driving device 133, the second driving device 134, and the third driving device, or the printer 226.

The image obtaining circuit 352 is an example of an image obtainer, and has substantially the same functions as the image obtaining unit 152. The image obtaining circuit 352 receives the second media signal from the second reception circuit 132, and controls the first imaging device 116 or 216 or the second imaging device 120 or 220 based on the received second media signal. The image obtaining circuit 352 obtains an input image from the first imaging device 116 or 216 or the second imaging device 120 or 220, and outputs the input image to the interface device 135.

The imaging apparatus including the processing circuit 350 can reduce the influence of a radio wave generated by radio wave generation sources without increases in the apparatus size.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An imaging apparatus comprising:
a conveying path inclined downward from upstream toward downstream in a medium conveying direction;
a first imager to image a medium that is conveyed;
a circuit board located below the conveying path;
multiple electronic components mounted on the circuit board and having different heights; and
a first shield located above the multiple electronic components to attenuate a radio wave generated by the first imager, wherein
the multiple electronic components include a first electronic component mounted on an upstream portion of the circuit board located below an upstream position in the medium conveying direction, and a second electronic component that is smaller in height than the first electronic component and mounted on a downstream portion of the circuit board located below a position downstream from the upstream position in the medium conveying direction, and
the first shield is inclined downward from the first electronic component toward the second electronic component and covers an upper side of the multiple electronic components.

2. The imaging apparatus according to claim 1, further comprising:
a second imager located below the circuit board; and
a second shield located between the second imager and the circuit board to attenuate a radio wave from the second imager, wherein
the second shield is substantially parallel to the circuit board.

3. The imaging apparatus according to claim 2, further comprising:
an automatic document feeder in which the first imager is located; and
a flatbed section in which the second imager is located.

4. The imaging apparatus according to claim 1, further comprising:
a printer including an image forming circuit board on which an image forming electronic component and an image forming conductor for image formation is mounted; and
a second shield located between the circuit board and the image forming circuit board to attenuate a radio wave generated by the image forming electronic component and the image forming conductor on the image forming circuit board.

5. The imaging apparatus according to claim 2, wherein
each of the first shield and the second shield includes at least one of a resin having a surface resistance value equal to or lower than 10¹⁰ Ω, a member coated with a conductive coating film, or a metal.

6. The imaging apparatus according to claim 2, further comprising a conductor mounted on the circuit board, wherein
the first shield is located between the first imager and the multiple electronic components and the conductor mounted on the circuit board, and
the second shield is located between the second imager and the multiple electronic components and the conductor mounted on the circuit board.
